(19) United States
(12) Patent Application Publication
(10) Pub. No.: US 2024/0351811 A1
(43) Pub. Date: Oct. 24, 2024

(54) MEDIA CONVEYANCE DEVICE

(71) Applicant: PFU LIMITED, Kahoku-shi, ISHIKAWA (JP)

(72) Inventors: Syuichi MORIKAWA, Kahoku-shi (JP); Kiichiro SHIMOSAKA, Kahoku-shi (JP)

(21) Appl. No.: 18/689,387

(22) PCT Filed: Sep. 15, 2021
(86) PCT No.: PCT/JP2021/033975

§ 371 Date: Mar. 5, 2024

(51) Int. Cl. B65H 5/06

(52) U.S. Cl. CPC B65H 5/062; B65H 2404/4213; B65H 2511/14; B65H 2515/34; B65H 2515/81; B65H 2801/12

(57) ABSTRACT

Provided is a medium conveying apparatus capable of conveying a medium satisfactorily. A medium conveying apparatus includes a first conveyance roller pair, a first pressing part to press one roller of the first conveyance roller pair to the other roller, a second conveyance roller pair, and a second pressing part to press one roller of the second conveyance roller pair to the other roller. A pressing force of the second pressing part is less than a pressing force of the first pressing part. At least one roller of the first conveyance roller pair and at least one roller of the second conveyance roller pair are driven by a same motor. A diameter of at least one roller of the second conveyance roller pair is greater than a diameter of at least one roller of the first conveyance roller pair.

### TECHNICAL FIELD

The present disclosure relates to a medium conveying apparatus and particularly relates to a medium conveying apparatus including two conveyance roller pairs.

### BACKGROUND ART

In general, a medium conveying apparatus such as a scanner generates an image by imaging a medium conveyed by a conveyance roller pair. When a medium is not satisfactorily conveyed in such a medium conveying apparatus, distortion may occur in the image acquired by imaging the medium.

A sheet material conveying apparatus including two or more conveyance roller pairs to convey a sheet material is disclosed (see PTL 1). In the sheet material conveying apparatus, when handover of a sheet material is performed between two conveyance roller pairs, the circumferential speed of a first conveyance roller pair on an upstream side in a conveying direction is lower than the circumferential speed of a second conveyance roller pair on a downstream side in the conveying direction. Further, in the sheet material conveying apparatus, the conveyance force of the first conveyance roller pair is greater than the conveyance force of the second conveyance roller pair, and the roller material of the second conveyance roller pair is an elastic material with a low friction coefficient.

### CITATION LIST

### Patent Literature

[PTL 1]

Japanese Unexamined Patent Publication (Kokai) No. H6-321384

### SUMMARY OF INVENTION

It is preferable that the medium conveying apparatus satisfactorily convey a medium.

An object of the medium conveying apparatus is to convey a medium satisfactorily.

According to some embodiments, a medium conveying apparatus includes a feed roller to feed a medium, a separation roller located to face the feed roller and provided to be rotatable in a direction opposite to a medium feeding direction or stoppable, a first conveyance roller pair located on a downstream side of the feed roller and the separation roller in a medium conveying direction to convey the medium fed by the feed roller while the separation roller is rotating in the direction opposite to the medium feeding direction or stopping, a first pressing part to press one roller of the first conveyance roller pair to the other roller, a processing device located on a downstream side of the first conveyance roller pair in the medium conveying direction to execute predetermined processing on the medium conveyed by the first conveyance roller pair, a second conveyance roller pair located on a downstream side of the processing device in the medium conveying direction to convey the medium on which the predetermined processing is being executed by the processing device, and a second pressing part to press one roller of the second conveyance roller pair to the other roller. A pressing force of the second pressing part is less than a pressing force of the first pressing part. At least one roller of the first conveyance roller pair and at least one roller of the second conveyance roller pair are driven by a same motor. A diameter of at least one roller of the second conveyance roller pair is greater than a diameter of at least one roller of the first conveyance roller pair.

According to some embodiments, a medium conveying apparatus includes a feed roller to feed a medium, a separation roller located to face the feed roller and provided to be rotatable in a direction opposite to a medium feeding direction, or stoppable, a first conveyance roller pair located on a downstream side of the feed roller and the separation roller in a medium conveying direction to convey the medium fed by the feed roller while the separation roller is rotating in the direction opposite to the medium feeding direction, or stopping, a first pressing part to press one roller of the first conveyance roller pair to the other roller, a processing device located on a downstream side of the first conveyance roller pair in the medium conveying direction, to execute predetermined processing on the medium conveyed by the first conveyance roller pair, a second conveyance roller pair located on a downstream side of the processing device in the medium conveying direction to convey the medium on which the predetermined processing is being executed by the processing device, and a second pressing part to press one roller of the second conveyance roller pair to the other roller. A pressing force of the second pressing part is less than a pressing force of the first pressing part. At least one roller of the first conveyance roller pair and at least one roller of the second conveyance roller pair are driven by a same motor. Hardness of at least one roller of the second conveyance roller pair is lower than hardness of at least one roller of the first conveyance roller pair.

The medium conveying apparatus according to the present embodiment can satisfactorily convey a medium.

The object and advantages of the invention will be realized and attained by means of the elements and combinations, in particular, described in the claims. It is to be understood that both the foregoing general description and the following detailed description are exemplary and explanatory, and are not restrictive of the invention, as claimed.

### BRIEF DESCRIPTION OF DRAWINGS

FIG. 1 is a perspective view illustrating a medium conveying apparatus 100 according to an embodiment.

FIG. 2 is a diagram for illustrating a conveyance path inside the medium conveying apparatus 100.

FIG. 3 is a schematic diagram for illustrating a force applied to each roller.

FIG. 4 is a schematic diagram illustrating a state in which the front edge of a medium M arrives at a nip position.

FIG. 5A is a schematic diagram for illustrating a push-in force.

FIG. 5B is a schematic diagram for illustrating the push-in force.

FIG. 6 is a schematic diagram for illustrating a relation between a pressing force and a conveyance distance.

FIG. 7 is a graph illustrating a relation between the pressing force and an overfeeding rate.

FIG. 8 is a graph illustrating a relation between the pressing force and the overfeeding rate.

FIG. 9 is a block diagram illustrating a schematic configuration of the medium conveying apparatus 100.

FIG. 10 is a diagram illustrating a schematic configuration of a storage device 140 and a processing circuit 150.

FIG. 11 is a flowchart illustrating an operation example of medium reading processing.

FIG. 12 is a diagram illustrating a schematic configuration of another processing circuit 250.

### DESCRIPTION OF EMBODIMENTS

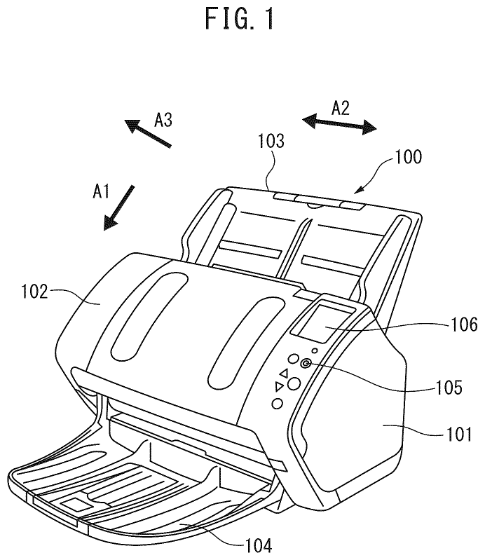

Hereinafter, a medium conveying apparatus, a control method and a control program according to an embodiment, will be described with reference to the drawings. However, it should be noted that the technical scope of the invention is not limited to these embodiments, and extends to the inventions described in the claims and their equivalents. FIG. 1 is a perspective view illustrating a medium conveying apparatus 100 configured as an image scanner. The medium conveying apparatus 100 conveys and images a medium being a document. Examples of a medium include paper, thin paper, thick paper, a card, and an envelope. The medium conveying apparatus 100 may be a facsimile, a copying machine, a multifunctional peripheral (MFP), etc. A conveyed medium may be an object being printed on, etc., instead of a document, and the medium conveying apparatus 100 may be a printer, etc.

The medium conveying apparatus 100 includes a lower housing 101, an upper housing 102, a loading tray 103, an ejection tray 104, an operation device 105, a display device 106, etc. In FIG. 1, an arrow Al indicates a medium conveying direction, an arrow A2 indicates a width direction perpendicular to the medium conveying direction, and an arrow A3 indicates a height direction perpendicular to a medium conveyance surface. Hereinafter, an upper stream refers to an upper stream in the medium conveying direction A1, and a lower stream refers to a lower stream in the medium conveying direction A1.

The upper housing 102 is located at a position covering the top surface of the medium conveying apparatus 100 and is engaged with the lower housing 101 by a hinge to be openable when, for example, a medium is stuck or cleaning of the inside of the medium conveying apparatus 100 is performed.

The loading tray 103 is engaged with the lower housing 101 and places a medium to be fed and conveyed. The ejection tray 104 is engaged with the upper housing 102 and places an ejected medium. The ejection tray 104 may be engaged with the lower housing 101.

The operation device 105 includes an input device such as a button, and an interface circuit acquiring a signal from the input device, accepts an input operation by a user, and outputs an operation signal based on the input operation by the user. The display device 106 includes a display including a liquid crystal, an organic electro-luminescence (EL), etc., and an interface circuit outputting image data to the display, and displays the image data on the display.

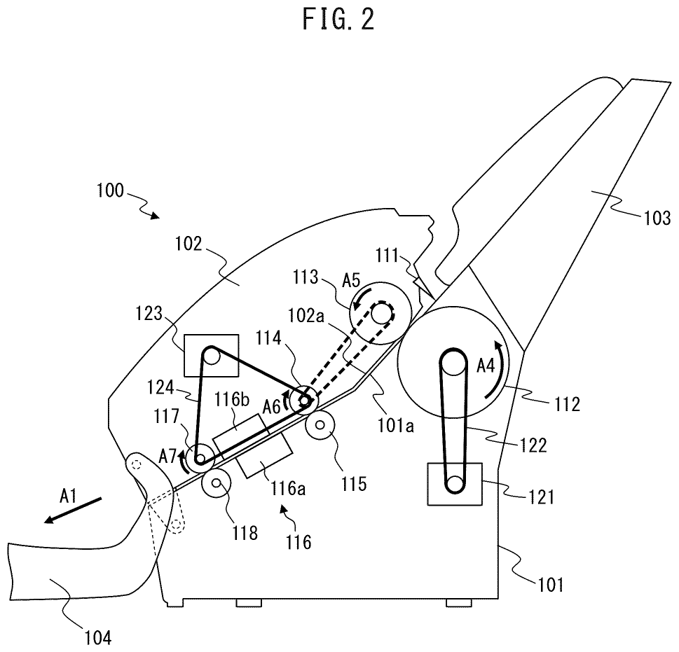

FIG. 2 is a diagram for illustrating a conveyance path inside the medium conveying apparatus 100.

The conveyance path inside the medium conveying apparatus 100 includes a medium sensor 111, a feed roller 112, a separation roller 113, a first conveyance roller 114, a first driven roller 115, an imaging device 116, a second conveyance roller 117, a second driven roller 118, etc. Further, the medium conveying apparatus 100 includes a first motor 121, a first transmission mechanism 122, a second motor 123, a second transmission mechanism 124, etc.

Each of the numbers of the feed roller 112, the separation roller 113, the first conveyance roller 114, the first driven roller 115, the second conveyance roller 117, and/or the second driven roller 118 is not limited to one and may be more than one. In that case, a plurality of feed rollers 112, separation rollers 113, first conveyance rollers 114, first driven rollers 115, second conveyance rollers 117, and/or second driven rollers 118 are respectively spaced in the width direction A2.

The top surface of the lower housing 101 forms a lower guide 101a of the conveyance path of a medium, and the bottom surface of the upper housing 102 forms an upper guide 102a of the conveyance path of a medium. The lower guide 101a forms the medium conveyance surface.

The medium sensor 111 is placed on the upstream side of the feed roller 112 and the separation roller 113. The medium sensor 111 includes a contact detection sensor and detects whether a medium is placed in the loading tray 103. The medium sensor 111 generates and outputs a medium signal the signal value of which varies between a state in which a medium is placed in the loading tray 103 and a state in which a medium is not placed. The medium sensor 111 is not limited to a contact detection sensor, and any other sensor that can detect existence of a medium, such as a light detection sensor, may be used as the medium sensor 111.

The feed roller 112 is provided in the lower housing 101, sequentially separates media placed in the loading tray 103 from the lower side, and feeds the media. The separation roller 113 is a so-called brake roller or retard roller, is provided in the upper housing 102, and is located to face the feed roller 112. The separation roller 113 is provided to be rotatable in a direction opposite to the medium feeding direction or stoppable. As a feed mode, the medium conveying apparatus 100 has a separation mode in which a medium is separated and fed and a non-separation mode in which a medium is fed without being separated. The feed mode is set by a user by using the operation device 105 or an information processing apparatus communicatively connected to the medium conveying apparatus 100. When the feed mode is set to the separation mode, the separation roller 113 separates a medium by rotating in the direction opposite to the medium feeding direction or stopping. On the other hand, when the feed mode is set to the non-separation mode, the separation roller 113 rotates in the medium feeding direction. The feed roller 112 may be provided in the upper housing 102, the separation roller 113 may be provided in the lower housing 101, and the feed roller 112 may sequentially feed media placed in the loading tray 103 from the upper side.

The first conveyance roller 114 and the first driven roller 115 are an example a first conveyance roller pair and are located on the downstream side of the feed roller 112 and the separation roller 113 to face each other. The first conveyance roller 114 is provided in the upper housing 102 and conveys a medium fed by the feed roller 112 and the separation roller 113 to the imaging device 116. The first driven roller 115 is provided in the lower housing 101 and below the first conveyance roller 114 and is driven to rotate by the first conveyance roller 114. In other words, the first conveyance roller 114 and the first driven roller 115 are provided to convey a medium fed by the feed roller 112 while the separation roller 113 is rotating in the direction opposite to the medium feeding direction or stopping, in the separation mode. The first conveyance roller 114 may be provided in the lower housing 101, and the first driven roller 115 may be provided in the upper housing 102.

The imaging device 116 is an example of a processing device, is located on the downstream side of the first conveyance roller 114 and the first driven roller 115 in the medium conveying direction Al, and executes imaging process on a medium conveyed by the first conveyance roller 114 and the first driven roller 115. The imaging process is an example of predetermined processing. The imaging device 116 includes a first imaging device 116a and a second imaging device 116b located to face each other with the medium conveyance path in between.

The first imaging device 116a includes a line sensor based on a unity-magnification optical system type contact image sensor (CIS) including Complementary Metal Oxide Semiconductor-(CMOS-) based imaging elements linearly arranged in a main scanning direction. The first imaging device 116a further includes lenses each forming an image on an imaging element, and an A/D converter amplifying and analog-digital (A/D) converting an electric signal output from the imaging element. The first imaging device 116a generates an input image by imaging the front side of a conveyed medium in accordance with control from a processing circuit to be described later and outputs the generated image.

Similarly, the second imaging device 116b includes a line sensor based on a unity-magnification optical system type CIS including CMOS-based imaging elements linearly arranged in the main scanning direction. The second imaging device 116b further includes lenses each forming an image on an imaging element, and an A/D converter amplifying and analog-digital (A/D) converting an electric signal output from the imaging element. The second imaging device 116b generates an input image by imaging the back side of a conveyed medium in accordance with control from the processing circuit to be described later and outputs the generated image. Only one of the first imaging device 116a and the second imaging device 116b may be located and only one side of a medium may be read in the medium conveying apparatus 100. Further, a line sensor based on a unity-magnification optical system type CIS including Charge Coupled Device-(CCD-) based imaging elements may be used in place of the line sensor based on a unity-magnification optical system type CIS including CMOS-based imaging elements. Further, a reduction optical system type line sensor including CMOS-based or CCD-based imaging elements may be used.

The second conveyance roller 117 and the second driven roller 118 are an example of a second conveyance roller pair and are located on the downstream side of the imaging device 116 to face each other. The second conveyance roller 117 is provided in the upper housing 102, conveys a medium being conveyed by the first conveyance roller 114 and the first driven roller 115 and being imaged by the imaging device 116 further to the downstream side, and ejects the medium into the ejection tray 104. The second driven roller 118 is provided in the lower housing 101 and below the second conveyance roller 117 and is driven to rotate by the second conveyance roller 117. In other words, the second conveyance roller 117 and the second driven roller 118 are provided to convey a medium on which the imaging process is being executed by the imaging device 116. The second conveyance roller 117 may be provided in the lower housing 101, and the second driven roller 118 may be provided in the upper housing 102.

The first motor 121 is provided in the lower housing 101 and is connected to the feed roller 112 through the first transmission mechanism 122. The first motor 121 generates a first driving force for rotating the feed roller 112 in accordance with a control signal from a processing circuit to be described later.

The first transmission mechanism 122 includes one or a plurality of pulleys, belts, gears, etc., that are provided between the first motor 121 and a shaft being the rotation axis of the feed roller 112. The first transmission mechanism 122 transmits the first driving force generated by the first motor 121 to the feed roller 112.

The second motor 123 is an example of a motor, is provided in the upper housing 102, and is connected to the first conveyance roller 114, the second conveyance roller 117, and the separation roller 113 through the second transmission mechanism 124. The second motor 123 generates a second driving force for rotating the first conveyance roller 114, the second conveyance roller 117, and the separation roller 113 in accordance with a control signal from the processing circuit.

The second transmission mechanism 124 includes one or a plurality of pulleys, belts, gears, etc., that are provided between the second motor 123 and shafts being the rotation axes of the separation roller 113, the first conveyance roller 114, and the second conveyance roller 117. In particular, one or a plurality of gears for varying the rotation direction and the rotation speed of the separation roller 113 are provided between the shaft of the first conveyance roller 114 and the shaft of the separation roller 113. The second transmission mechanism 124 transmits the second driving force generated by the second motor 123 to the separation roller 113, the first conveyance roller 114, and the second conveyance roller 117.

The first driven roller 115 and/or the second driven roller 118 may be a conveyance roller rotated by the second driving force from the second motor 123. Consequently, the conveyance force exerted on a medium by each roller increases, and the medium conveying apparatus 100 can satisfactorily convey the medium even when the pressing force between the first conveyance roller 114 and the first driven roller 115 and/or the pressing force between the second conveyance roller 117 and the second driven roller 118 is weak.

The separation roller 113 may not be connected to the second motor 123 through the second transmission mechanism 124 and may be connected to the first motor 121 through the first transmission mechanism 122 and be provided to be rotated by the first driving force generated by the first motor 121. Further, the first motor 121 may be located in the upper housing 102 instead of the lower housing 101. The second motor 123 may be located in the lower housing 101 instead of the upper housing 102.

Thus, at least one roller of the first conveyance roller pair and at least one roller of the second conveyance roller pair are driven by the same second motor 123. Consequently, the medium conveying apparatus 100 can share a motor between a plurality of rollers and can achieve reduction in the apparatus size and the apparatus cost.

The feed roller 112 rotates in a direction of an arrow A4 by rotation of the first motor 121. When the feed mode is set to the separation mode, the separation roller 113 rotates in a direction of an arrow A5 or stops, and the first conveyance roller 114 and the second conveyance roller 117 rotate in directions of arrows A6 and A7, respectively, by rotation of the second motor 123.

A medium placed in the loading tray 103 is conveyed between the lower guide 101a and the upper guide 102a toward the medium conveying direction Al by the feed roller 112 rotating in the direction of the arrow A4, i.e., the medium feeding direction. When the feed mode is set to the separation mode, the separation roller 113 rotates in the direction of the arrow A5, i.e., the direction opposite to the medium feeding direction or stops. When a plurality of media are placed in the loading tray 103, only a medium in contact with the feed roller 112 out of the medium placed in the loading tray 103 is separated by working of the feed roller 112 and the separation roller 113. Consequently, conveyance of a medium other than the separated medium is restricted (prevention of multi feed).

A medium is fed between the first conveyance roller 114 and the first driven roller 115 while being guided by the lower guide 101a and the upper guide 102a. The medium is fed between the first imaging device 116a and the second imaging device 116b by the first conveyance roller 114 rotating in directions of an arrow A6. The medium read by the imaging device 116 is ejected into the ejection tray 104 by the second conveyance roller 117 rotating in directions of an arrow A7.

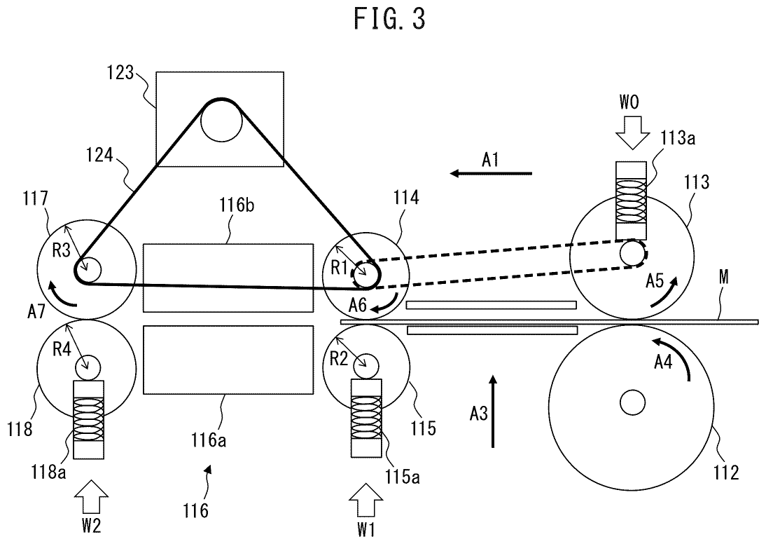

FIG. 3 is a schematic diagram for illustrating forces applied to the separation roller 113, the first driven roller 115, and the second driven roller 118.

As illustrated in FIG. 3, the medium conveying apparatus 100 further includes a separation roller pressing member 113a, a first pressing member 115a, and a second pressing member 118a.

One end of the separation roller pressing member 113a is provided in the upper housing 102 and the other end is provided on the shaft being the rotation axis of the separation roller 113, and the separation roller pressing member 113a presses the separation roller 113 to the feed roller 112. The separation roller pressing member 113a includes an elastic member such as a helical torsion coil spring and generates a pressing force W0 pressing the separation roller 113 to the feed roller 112. The separation roller pressing member 113a may include a different spring member such as a flat spring, a rubber member, etc.

The first pressing member 115a is an example a first pressing part, and one end of the first pressing member 115a is provided in the lower housing 101 and the other end is provided on a shaft being a rotation axis of the first driven roller 115, and the first pressing member 115a presses the first driven roller 115 to the first conveyance roller 114. The first pressing member 115a includes an elastic member such as a helical torsion coil spring and generates a pressing force W1 pressing the first driven roller 115 to the first conveyance roller 114. The first pressing member 115a may include a different spring member such as a flat spring, a rubber member, etc.

Further, the first pressing member 115a may be provided to press the first conveyance roller 114 to the first driven roller 115. Thus, the first pressing member 115a presses one roller of the first conveyance roller pair to the other roller.

The second pressing member 118a is an example of a second pressing part, and one end of the second pressing member 118a is provided in the lower housing 101 and the other end is provided on a shaft being the rotation axis of the second driven roller 118; and the second pressing member 118a presses the second driven roller 118 to the second conveyance roller 117. The second pressing member 118a includes an elastic member such as a helical torsion coil spring and generates a pressing force W2 pressing the second driven roller 118 to the second conveyance roller 117. The second pressing member 118a may include a different spring member such as a flat spring, a rubber member, etc. Further, the second pressing member 118a may be provided to press the second conveyance roller 117 to the second driven roller 118. Thus, the second pressing member 118a presses one roller of the second conveyance roller pair to the other roller.

The pressing force W2 generated by the second pressing member 118a is less than the pressing force W1 generated by the first pressing member 115a.

The diameter R3 of the second conveyance roller 117 is greater than the diameter R1 of the first conveyance roller 114. The diameter R4 of the second driven roller 118 is greater than the diameter R2 of the first driven roller 115. The diameter R4 of the second driven roller 118 may be equal to the diameter R2 of the first driven roller 115 or less than the diameter R2 of the first driven roller 115.

When the first driven roller 115 is a conveyance roller rotated by the second driving force from the second motor 123, it is preferable that the diameter R1 of the first conveyance roller 114 and the diameter R2 of the first driven roller 115 are the same. Similarly, when the second driven roller 118 is a conveyance roller rotated by the second driving force from the second motor 123, it is preferable that the diameter R3 of the second conveyance roller 117 and the diameter R4 of the second driven roller 118 are the same. Consequently, the conveyance force exerted by a roller located on the upper side becomes identical to the conveyance force exerted by a roller located on the lower side, and the medium conveying apparatus 100 can suppress exertion of a stripping (shearing) force on a conveyed medium and can satisfactorily convey the medium.

In this case, the diameter R3 of the second conveyance roller 117 and the diameter R4 of the second driven roller 118 are greater than the diameter R1 of the first conveyance roller 114 and diameter R2 of the first driven roller 115, respectively. The diameter R1 of the first conveyance roller 114 and the diameter R2 of the first driven roller 115 may differ. Further, the diameter R3 of the second conveyance roller 117 and the diameter R4 of the second driven roller 118 may differ.

Thus, the diameter of at least one roller of the second conveyance roller pair is greater than the diameter of at least one roller of the first conveyance roller pair.

The technical meaning that the pressing force W2 applied to the second driven roller 118 on the downstream side by the second pressing member 118a is less than the pressing force W1 applied to the first driven roller 115 on the upstream side by the first pressing member 115a will be described below.

As illustrated in FIG. 3, after the front edge of a conveyed medium M passes a nip position of the first conveyance roller 114 and the first driven roller 115, the medium M is pulled by the first conveyance roller 114 and the first driven roller 115. At this time, the medium M receives a force exerted by the separation roller 113 toward the direction A5 opposite to the medium feeding direction at a nip position of the feed roller 112 and the separation roller 113. Accordingly, the pressing force W1 generated by the first pressing member 115a needs to be somewhat strong so as to withstand the force exerted by the separation roller 113 toward the direction A5 opposite to the medium feeding direction.

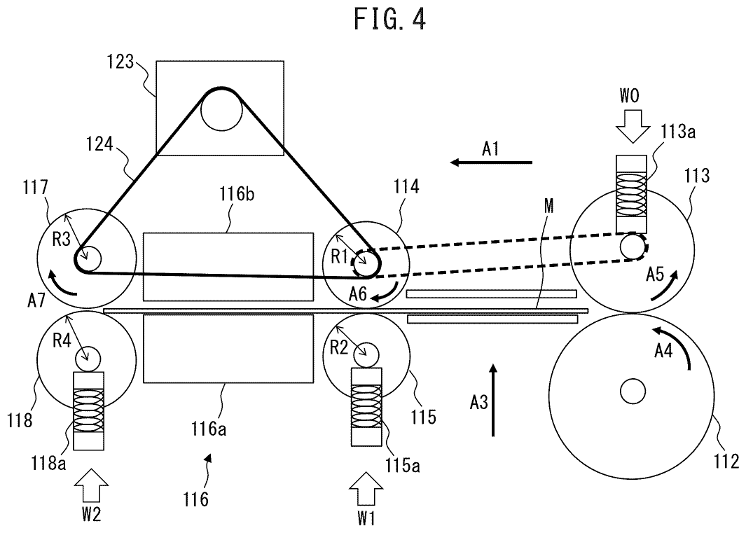

FIG. 4 is a schematic diagram illustrating a state in which the front edge of the medium M arrives at a nip position of the second conveyance roller 117 and the second driven roller 118.

As illustrated in FIG. 4, when the front edge of the conveyed medium M arrives at the nip position of the second conveyance roller 117 and the second driven roller 118, imaging process by the imaging device 116 is being executed on the medium M. At this time, when the pressing force W2 generated by the second pressing member 118a is excessively strong, the front edge of the medium M may not smoothly enter the nip position of the second conveyance roller 117 and the second driven roller 118 and may cause a collision, which may bend the medium M. In that case, an input image generated by the imaging device 116 may include distortion in a main scanning direction and/or a subscanning direction. Accordingly, the pressing force W2 generated by the second pressing member 118a needs to be somewhat weak such that the front edge of the medium M can enter the nip position of the second conveyance roller 117 and the second driven roller 118.

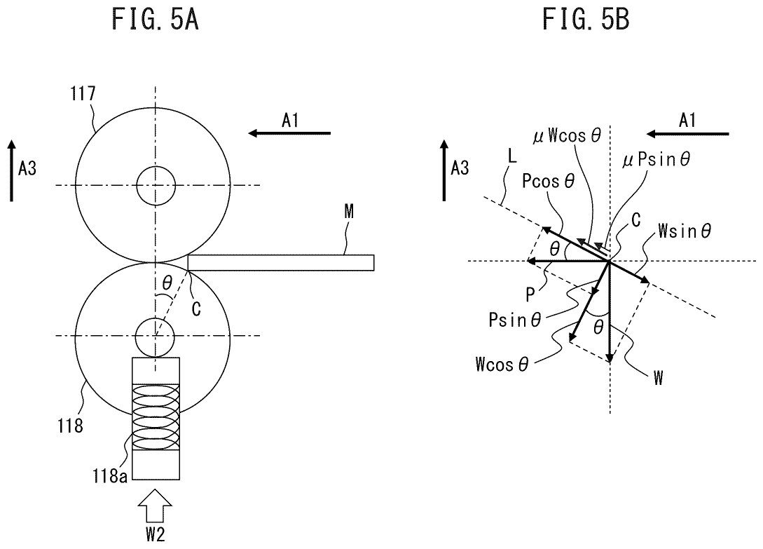

FIG. 5A and FIG. 5B are schematic diagrams for illustrating a push-in force exerted on a nip position by the front edge of the medium M. FIG. 5A is a schematic diagram illustrating the second conveyance roller 117 and the second driven roller 118 viewed from the side, and FIG. 5B is a schematic diagram illustrating a relation between forces at a position C where the second driven roller 118 comes into contact with the medium M.

As illustrated in FIG. 5A, the second conveyance roller 117 and the second driven roller 118 form a nip and the medium M has a certain thickness, and therefore the front edge of the medium M comes into contact with the second driven roller 118 at the predetermined position C on the upstream side of the nip position before entering the nip position. As illustrated in FIG. 5B, a push-in force P on the nip position along the medium conveying direction Al and a reaction force W of the pressing force W2 generated by the second pressing member 118a along the height direction A3 perpendicular to the medium conveying direction are exerted on the front edge of the medium M at the predetermined position C. In FIG. 5B, a straight line L indicates a straight line tilted relative to the medium conveying direction Al by an angle θ formed by a straight line passing through the center position of the second conveyance roller 117 and the center position of the second driven roller 118, and a straight line passing through the center position of the second conveyance roller 117 and the predetermined position C.

A force based on the push-in force P (P cos θ), a frictional force between the medium M and the second driven roller 118 (μP sin θ) based on the push-in force P, and a frictional force between the medium M and the second driven roller 118 (μW cos θ) based on the reaction force W are generated toward the upstream side on the straight line L. Note that μ denotes the friction coefficient between the medium M and the second driven roller 118. On the other hand, a force based on the reaction force W (W sin θ) is generated toward the downstream side on the straight line L. Since the force toward the upstream side needs to be greater than the force toward the downstream side on the straight line L in order for the medium M to suitably enter the nip position, Equation (1) below needs to be satisfied.

$$P cos θ + µ P sin θ + µ W cos θ > W sin θ \qquad ( 1 )$$

From Equation (1), Equation (2) below needs to hold.

$$P > W ( sin θ - µcosθ ) / ( co s θ + µsinθ ) \qquad ( 2 )$$

In order for Equation (2) to be satisfied, the reaction force W of the pressing force W2 generated by the second pressing member 118a is preferably as weak as possible, and the pressing force W2 generated by the second pressing member 118a is preferably as weak as possible. In particular, the medium conveying apparatus 100 can satisfactorily convey a medium with some thickness, such as a card, by decreasing the pressing force W2 generated by the second pressing member 118a.

The pressing force W2 between the second conveyance roller 117 and the second driven roller 118 has only to be a minimum force for ejecting a medium, and the medium conveying apparatus 100 can reduce power consumption by decreasing the pressing force W2.

As described above, the pressing force W2 generated by the second pressing member 118a is less than the pressing force W1 generated by the first pressing member 115a in the medium conveying apparatus 100. Consequently, the medium conveying apparatus 100 can acquire a satisfactory input image by the imaging device 116 suitably imaging a medium while satisfactorily conveying the medium against a separating force applied to the medium by the separation roller 113.

Relations among the pressing force W1 generated by the first pressing member 115a, the pressing force W2 generated by the second pressing member 118a, and the pressing force W0 generated by the separation roller pressing member 113a will be described below.

As a result of performing an experiment of conveying and imaging A3-size paper while varying the pressing force W2 generated by the second pressing member 118a, the pressing force W2 needs to be set to about 1.5 [kgf] in order to smoothly eject the A3-size paper and acquire an input image without distortion.

On the other hand, generally, a force in a range of greater than or equal to 500 [gf] and less than or equal to 900 [gf] (equal to or greater than 4.9 [N] and equal to or less than 8.8 [N]) is necessary as a force for returning a medium to the upstream side by a separation roller. Assuming that the total size (roller width) of one or a plurality of conveyance rollers provided on the downstream side of the separation roller in the width direction is 40 mm, a load tension exerted on the conveyance roller is equal to or greater than 0.12 [N/mm] and equal to or less than 0.22 [N/mm].

FIG. 15 in “Noriaki Okamoto, ‘Contact Mechanics in Friction Drives with Rubber-Covered Rollers,’ Journal of The Society of Rubber Science and Technology, Japan, Vol. 74, No. 8 (2001) p. 300” illustrates a graph indicating a paper conveyance speed characteristic of a roller. For each of a plurality of rollers with different load tensions, the graph illustrates a relation between the pressing force [N/mm] with a facing roller and the speed ratio of the medium conveyance speed (a value acquired by dividing the medium conveyance speed by the circumferential speed of the roller). The graph tells that the pressing force needs to be set to 0.4 [N/mm] or greater in order to keep the speed ratio of a roller with a load tension of 0.11 [N/mm] within a range close to 1 (greater than or equal to 0.99 and less than or equal to 1.01). In other words, when the pressing force is greater than or equal to 3.6 times the load tension (=0.4 [N/mm]/0.11 [N/mm]), the speed ratio is kept within the range close to 1. Further, the graph tells that the pressing force needs to be set to 0.8 [N/mm] or greater in order to keep the speed ratio of a roller with a load tension of 0.216 [N/mm] within the range close to 1 (greater than or equal to 0.99 and less than or equal to 1.01). In other words, when the pressing force is greater than or equal to 3.7 times the load tension (=0.8 [N/mm]/0.216 [N/mm]), the speed ratio is kept within the range close to 1.

Accordingly, when the pressing force is about four times the load tension, the speed ratio of the medium conveyance speed is kept within the range close to 1, and the medium conveyance speed becomes almost equal to the circumferential speed of the roller; and occurrence of a slip of the medium by a roller is suppressed. As described above, generally, a force in a range of greater than or equal to 500 [f] and less than or equal to 900 [gf] is necessary as a force returning a medium to the upstream side exerted by the separation roller. Therefore, when the pressing force W1 generated by the first pressing member 115a is greater than or equal to 2.0 [kgf] and less than or equal to 3.6 [kgf], the speed ratio of the medium conveyance speed is kept within the range close to 1, and occurrence of a slip of a medium by a roller is suppressed.

As described above, in order to smoothly eject A3-size paper and acquire an input image without distortion, the pressing force W2 generated by the second pressing member 118a needs to be about 1.5 [kgf]. Therefore, it is desirable that the pressing force W1 generated by the first pressing member 115a and the pressing force W2 generated by the second pressing member 118a satisfy Equation (3) below.

$$W 1 / W 2 \geq 2 [ kgf ] / 15 [ kgf ] \approx 1.3 \qquad ( 3 )$$

Consequently, the medium conveying apparatus 100 can suppress occurrence of a slip of a medium by the first conveyance roller 114 while smoothly ejecting A3-size paper by the second conveyance roller 117 and acquiring an input image without distortion.

As a result of performing an experiment of conveying various types of media while varying the pressing force W0 generated by the separation roller pressing member 113a, the pressing force W0 needs to be greater than or equal to 300 [gf] and less than or equal to 600 [gf] in order to suppress occurrence of jam or multi feed of a medium. Therefore, it is desirable that the pressing force W1 generated by the first pressing member 115a and the pressing force W0 generated by the separation roller pressing member 113a satisfy Equation (4) below from a relation between the minimum value of W1 (2.0 [kgf]) and the maximum value of W0 (0.6 [kgf]).

$$W 1 / W 0 \geq 2. [ kgf ] / 0.6 [ kgf ] \approx 3 \qquad ( 4 )$$

Consequently, the medium conveying apparatus 100 can suppress occurrence of a slip of a medium by the first conveyance roller 114 while suppressing occurrence of jam or multi feed of a medium by the separation roller 113.

When the pressing force W1 generated by the first pressing member 115a is excessively strong, a reaction force is generated in the lower housing 101 supporting the first pressing member 115a, and bending occurs in the lower housing 101. In that case, the positions of parts provided in the lower housing 101 change, and the medium conveying apparatus 100 may not be able to satisfactorily convey a medium. Further, when the pressing force W1 generated by the first pressing member 115a is excessively strong, the first pressing member 115a considerably pushes up the shaft of the first driven roller 115. When the first pressing member 115a is located in the central part of the shaft of the first driven roller 115 in the width direction A2, and the first driven roller 115 is located outside the member, the first driven roller 115 is located below by the central part of the shaft being pushed up. Therefore, a protruding amount of the first driven roller 115 relative to the lower guide 101a decreases, it becomes difficult for the front edge of a conveyed medium to enter the nip part of the first conveyance roller 114 and the first driven roller 115, and jam of the medium may occur.

By setting an upper limit of the pressing force W1 generated by the first pressing member 115a in consideration of variations in design and machining among parts, the medium conveying apparatus 100 can suppress occurrence of bending at the lower housing 101 and the shaft of the first driven roller 115.

By setting the pressing force W2 generated by the second pressing member 118a to a small value, the conveyance force exerted by the second conveyance roller 117 and the second driven roller 118 may be reduced and a medium may not be satisfactorily pulled to the downstream side by the second conveyance roller 117 and the second driven roller 118. Consequently, bending of a medium M may occur between the second conveyance roller 117 and the second driven roller 118, and the first conveyance roller 114 and the first driven roller 115, and distortion may be included in an input image generated by the imaging device 116.

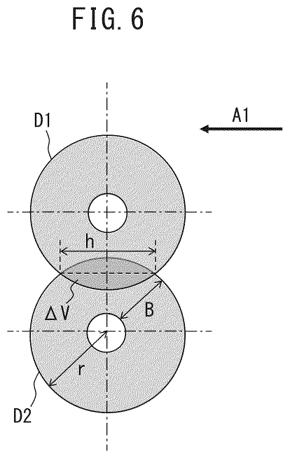

FIG. 6 is a schematic diagram for illustrating a relation between the pressing force exerted on a roller and the medium conveyance distance a by the roller. FIG. 6 is a schematic diagram of two rollers D1 and D2 facing each other viewed from the side.

In the example illustrated in FIG. 6, the roller D1 on the upper side is formed of a high-hardness member such as iron and the roller D2 on the lower side is formed of a low-hardness member such as rubber. In this case, the upper part of the roller D2 on the lower side is pressed by the roller D1 on the upper side, and the roller D2 on the lower side is deformed. An apparent radius R of the roller D2 on the lower side is calculated by Equation (5) below [see “Masataka Kawauchi, ‘Paper feeding and delivering machines and rubber materials,’ Journal of The Society of Rubber Science and Technology, Japan, Vol. 62, No. 11, pp. 683 to 694 (1989)”].

$$R = \sqrt{{r}^{2} ( \frac{Δ V}{hB} + 1 )} \qquad ( 5 )$$

Note that r denotes the actual radius of the roller D2 on the lower side. Further, h denotes the length of a nip part of the roller D1 on the upper side and the roller D2 on the lower side in a direction perpendicular to a straight line passing through the center position of the roller D1 on the upper side and the center position of the roller D2 on the lower side. B denotes the thickness of a rubber part of the roller D2 on the lower side. ΔV denotes the area of the nip part of the roller D1 on the upper side and the roller D2 on the lower side.

As indicated in Equation (5), the apparent radius R of the roller D2 formed of a low-hardness member depends on the area ΔV of the nip part of the roller D1 and the roller D2, and the apparent radius R of the roller D2 increases as the area ΔV increases. The area ΔV of the nip part of the roller D1 and the roller D2 depends on a pressing force generated between the roller D1 and the roller D2, and the area ΔV increases as the pressing force increases. Accordingly, as the pressing force generated between the roller D1 and the roller D2 increases, the apparent radius R of the roller D2 increases, and the medium conveyance distance when the roller D2 makes one revolution increases.

In other words, by the pressing force W2 generated by the second pressing member 118a being less than the pressing force W1 generated by the first pressing member 115a, the medium conveyance distance when the second conveyance roller 117 makes one revolution becomes less than the medium conveyance distance when the first conveyance roller 114 makes one revolution. Therefore, bending of a medium M may occur between the second conveyance roller 117 and the second driven roller 118, and the first conveyance roller 114 and the first driven roller 115, and distortion may be included in an input image generated by the imaging device 116.

For example, occurrence of bending of the medium M is suppressed by separately providing a motor driving the second conveyance roller 117 and a motor driving the first conveyance roller 114 and rotating the second conveyance roller 117 faster than the first conveyance roller 114. However, the apparatus size and the apparatus cost of the medium conveying apparatus increase in that case.

As described above, the first conveyance roller 114 of the first conveyance roller pair and the second conveyance roller 117 of the second conveyance roller pair are driven by the same second motor 123 in the medium conveying apparatus 100. Further, the diameter of the second conveyance roller 117 of the second conveyance roller pair is greater than the diameter of the first conveyance roller 114 of the first conveyance roller pair in the medium conveying apparatus 100.

Consequently, in the medium conveying apparatus 100, the medium conveyance speed of the second conveyance roller 117 can be set to a speed higher than the medium conveyance speed of the first conveyance roller 114 while sharing one second motor 123 between the first conveyance roller 114 and the second conveyance roller 117. Further, in the medium conveying apparatus 100, the medium conveyance speed of the second conveyance roller 117 can be set to a speed higher than the medium conveyance speed of the first conveyance roller 114 while simplifying the structure of the second transmission mechanism 124 without using a special structure such as a reduction gear. Accordingly, the medium conveying apparatus 100 can suppress occurrence of bending of a medium at the imaging position and can suppress occurrence of distortion in an input image while suppressing increase in the apparatus size and the apparatus cost.

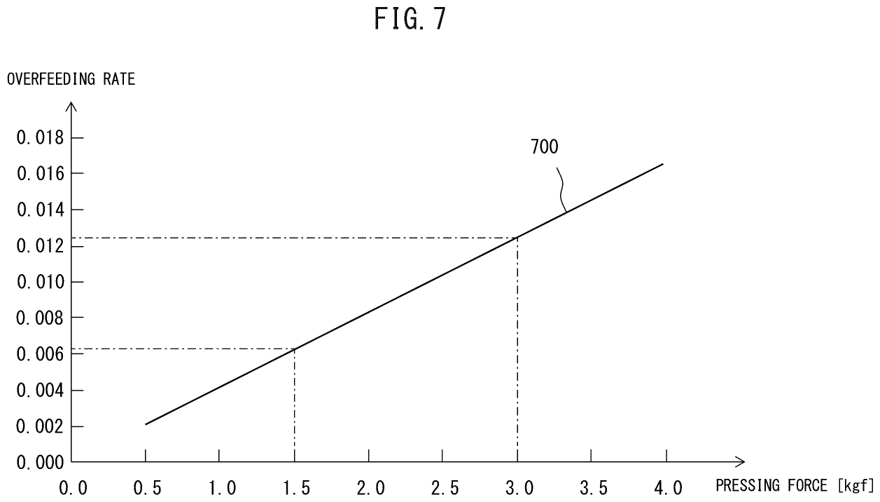

FIG. 7 is a graph 700 illustrating a relation between the pressing force exerted between two rollers facing each other and the overfeeding rate of the two rollers.

In the graph illustrated in FIG. 7, the horizontal axis indicates the pressing force [kgf] exerted between the two rollers facing each other, and the vertical axis indicates the overfeeding rate of the two rollers. The overfeeding rate is calculated by Equation (6) below, based on the actual radius r of a deformed roller and the apparent radius R.

$$( Overfeeding rate ) = ( R - r ) / r \qquad ( 6 )$$

As illustrated in the graph 700, as the pressing force exerted between the two rollers facing each other increases, the overfeeding rate of the two rollers increases. For example, when the pressing force W1 between the first conveyance roller 114 and the first driven roller 115 is 3 [kgf], the overfeeding rate of the first conveyance roller 114 and the first driven roller 115 is about 0.012. On the other hand, when the pressing force W2 between the second conveyance roller 117 and the second driven roller 118 is 1.5 [kgf], the overfeeding rate of the second conveyance roller 117 and the second driven roller 118 is about 0.006. Accordingly, by setting the diameter d1 of the first conveyance roller 114 and the diameter d2 of the second conveyance roller 117 to satisfy Equation (7) below, the medium conveying apparatus 100 can suppress occurrence of bending of a medium.

$$( d 2 - d 1 ) / d 1 \approx 0.012 - 0.006 \qquad ( 7 )$$

In the medium conveying apparatus 100, the hardness may be varied between a roller on the upstream side and a roller on the downstream side instead of varying the diameter of the roller on the upstream side and the diameter of the roller on the downstream side. In that case, the hardness of the second conveyance roller 117 is lower than the hardness of the first conveyance roller 114. The hardness of the second driven roller 118 is lower than the hardness of the first driven roller 115. The hardness of the second driven roller 118 may be the same as the hardness of the first driven roller 115 or higher than the hardness of the first driven roller 115.

When the first driven roller 115 is a conveyance roller rotated by the second driving force from the second motor 123, the hardness of the first conveyance roller 114 and the hardness of the first driven roller 115 are preferably set to the same magnitude. Similarly, when the second driven roller 118 is a conveyance roller rotated by the second driving force from the second motor 123, the hardness of the second conveyance roller 117 and the hardness of the second driven roller 118 are preferably set to the same magnitude. Consequently, the conveyance force exerted by a roller located on the upper side and the conveyance force exerted by a roller located on the lower side become identical, and the medium conveying apparatus 100 can suppress exertion of a stripping (shearing) force on a conveyed medium and can satisfactorily convey the medium.

In this case, the hardness of the second conveyance roller 117 and the hardness of the second driven roller 118 are lower than the hardness of the first conveyance roller 114 and the hardness of the first driven roller 115, respectively. The hardness of the first conveyance roller 114 and the hardness of the first driven roller 115 may differ. Further, the hardness of the second conveyance roller 117 and the hardness of the second driven roller 118 may be set to different magnitudes.

Thus, the hardness of at least one roller of the second conveyance roller pair is lower than the hardness of at least one roller of the first conveyance roller pair.

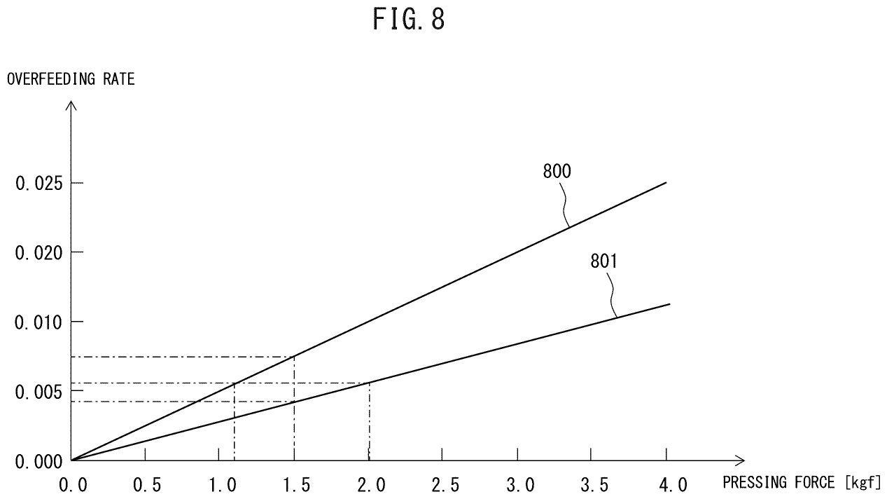

FIG. 8 is a graph illustrating a relation between the pressing force exerted between two rollers facing each other and the overfeeding rate of the two rollers.

In the graph illustrated in FIG. 8, the horizontal axis indicates the pressing force [kgf] exerted between the two rollers facing each other, and the vertical axis indicates the overfeeding rate of the two rollers. A graph 800 illustrated in FIG. 8 indicates the overfeeding rate when the rubber hardness of one conveyance roller of the two rollers facing each other defined by JIS-A is 45°. On the other hand, a graph 801 illustrated in FIG. 8 indicates the overfeeding rate when the rubber hardness of one conveyance roller of the two rollers facing each other defined by JIS-A is 60°.

As illustrated in FIG. 8, as the hardness of a conveyance roller becomes low (becomes softer), the overfeeding rate of the conveyance roller increases. By setting the hardness of the second conveyance roller 117 to be lower than the hardness of the first conveyance roller 114, the medium conveyance speed of the second conveyance roller 117 can be set to a speed higher than the medium conveyance speed of the first conveyance roller 114 in the medium conveying apparatus 100. Accordingly, the medium conveying apparatus 100 can suppress occurrence of bending of a medium at the imaging position and can suppress occurrence of distortion in an input image while reducing the apparatus size and the apparatus cost.

When a roller with hardness of 60° (graph 801) is used as the first conveyance roller 114 and the pressing force W1 exerted on the first conveyance roller 114 is 2 [kgf], the overfeeding rate of the first conveyance roller 114 and the first driven roller 115 is about 0.005. On the other hand, when a roller with hardness of 45° (graph 800) is used as the second conveyance roller 117 and the pressing force W2 exerted on the second conveyance roller 117 is 1.1 [kgf], the overfeeding rate of the second conveyance roller 117 and the second driven roller 118 is also about 0.005. In other words, the medium conveying apparatus 100 can eliminate the effect of the speed difference due to the pressing forces exerted on the first conveyance roller 114 and the second conveyance roller 117 by having a different hardness between the first conveyance roller 114 and the second conveyance roller 117. Accordingly, the medium conveying apparatus 100 can suppress occurrence of bending of a medium by having a different hardness between the first conveyance roller 114 and the second conveyance roller 117.

When the hardness is different between a roller on the upstream side and a roller on the downstream side, the diameter of the roller on the upstream side and the diameter of the roller on the downstream side may be the same. On the other hand, when the diameter is different between the roller on the upstream side and the roller on the downstream side, the hardness of the roller on the upstream side and the hardness of the roller on the downstream side may be the same.

The diameter of the second conveyance roller 117 may be greater than the diameter of the first conveyance roller 114 and, at the same time, the hardness of the second conveyance roller 117 may be lower than the hardness of the first conveyance roller 114 in the medium conveying apparatus 100.

As described above, for example, when the pressing force W1 between the first conveyance roller 114 and the first driven roller 115 is 3 [kgf], the overfeeding rate of the first conveyance roller 114 and the first driven roller 115 is about 0.012. On the other hand, when the pressing force W2 between the second conveyance roller 117 and the second driven roller 118 is 1.5 [kgf], the overfeeding rate of the second conveyance roller 117 and the second driven roller 118 is about 0.006. As illustrated in FIG. 8, when the pressing force between two rollers is 1.5 [kgf] and the rubber hardness of a roller is 45°, the overfeeding rate of the two rollers is about 0.004. On the other hand, when the pressing force between two rollers is 1.5 [kgf] and the rubber hardness of a roller is 60°, the overfeeding rate of the two rollers is about 0.007. Accordingly, by using a roller with hardness of 60° as the first conveyance roller 114 and using a roller with hardness of 45° as the second conveyance roller 117, the difference between the overfeeding rates of the two rollers can be set to about 0.003. In that case, by setting the diameter d1 of the first conveyance roller 114 and the diameter d2 of the second conveyance roller 117 to satisfy Equation (8) below, the medium conveying apparatus 100 can suppress occurrence of bending of a medium.

$$( d 2 - d 1 ) / d 1 \approx 0.003 \qquad ( 8 )$$

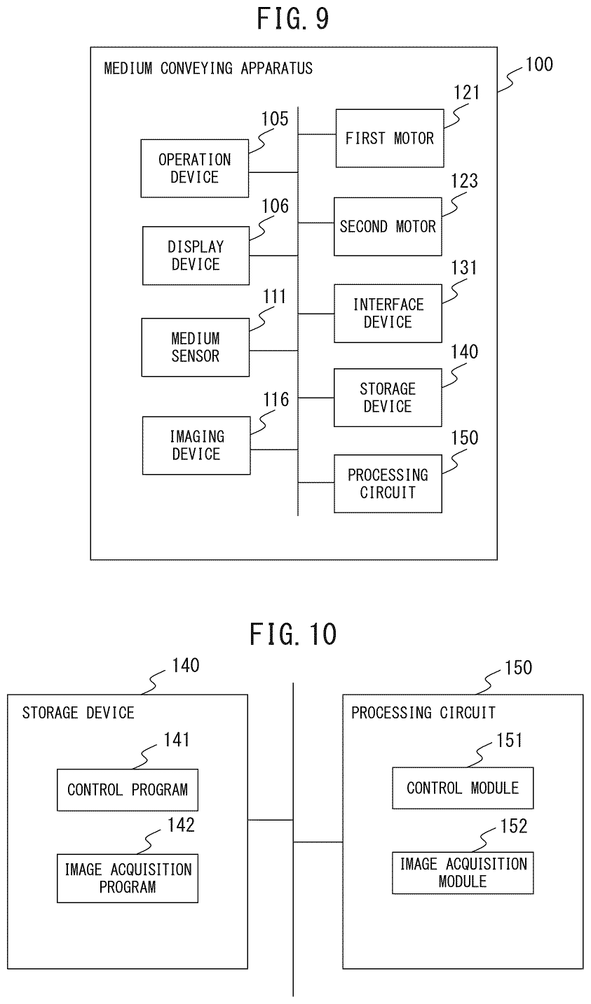

FIG. 9 is a block diagram illustrating a schematic configuration of the medium conveying apparatus 100.

In addition to the configuration described above, the medium conveying apparatus 100 further includes an interface device 131, a storage device 140, a processing circuit 150, etc.

For example, the interface device 131 includes an interface circuit conforming to a serial bus such as USB and transmits and receives an input image and various types of information to an unillustrated information processing apparatus (such as a personal computer or a mobile information terminal) via electrical connection. A communication device including an antenna transmitting and receiving wireless signals and a wireless communication interface circuit for transmitting and receiving signals through a wireless communication line in accordance with a predetermined communication protocol may be used in place of the interface device 131. For example, the predetermined communication protocol is a wireless local area network (LAN). The communication device may include a wired communication interface circuit for transmitting and receiving signals through a wired communication line in accordance with a communication protocol such as a wired LAN.

The storage device 140 includes a memory device such as a random-access memory (RAM) or a read-only memory (ROM), a fixed disk device such as a hard disk, a portable storage device such as a flexible disk or an optical disk, etc. Further, a computer program, a database, a table, etc., that are used for various types of processing in the medium conveying apparatus 100 are stored in the storage device 140. The computer programs may be installed on the storage device 140 from a computer-readable, non-transitory portable storage medium by using a well-known set-up program, etc. The portable storage medium is, for example, a compact disc read-only memory (CD-ROM) or a digital versatile disc read-only memory (DVD-ROM).

The processing circuit 150 operates in accordance with a program previously stored in the storage device 140. For example, the processing circuit is a central processing unit (CPU). Examples of the processing circuit 150 that may also be used include a digital signal processor (DSP), a large scale integration (LSI), an application specific integrated circuit (ASIC), and a field-programmable gate array (FPGA).

The processing circuit 150 is connected to the operation device 105, the display device 106, the medium sensor 111, the imaging device 116, the first motor 121, the second motor 123, the interface device 131, the storage device 140, etc., and controls the components. The processing circuit 150 performs drive control of the first motor 121 and the second motor 123, imaging control of the imaging device 116, etc., based on the medium signal received from the medium sensor 111. The processing circuit 150 acquires an input image from the imaging device 116 and transmits the acquired image to the information processing apparatus through the interface device 131.

FIG. 10 is a diagram illustrating a schematic configuration of the storage device 140 and the processing circuit 150.

As illustrated in FIG. 10, a control program 141, an image acquisition program 142, etc., are stored in the storage device 140. Each program is a functional module implemented by software operating on the processor. The processing circuit 150 reads each program stored in the storage device 140 and operates in accordance with the read program. Consequently, the processing circuit 150 functions as a control module 151, and an image acquisition module.

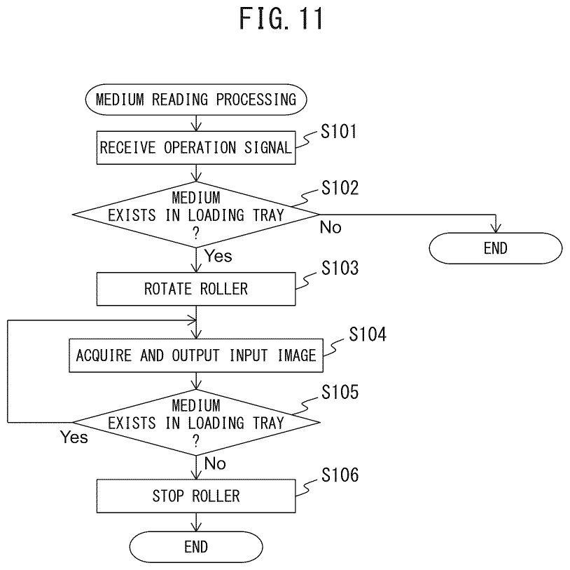

FIG. 11 is a flowchart illustrating an operation example of medium reading processing in the medium conveying apparatus 100.

The operation example of the medium reading processing in the medium conveying apparatus 100 will be described below referring to the flowchart illustrated in FIG. 11. The operation flow described below is executed mainly by the processing circuit 150 in accordance with a program previously stored in the storage device 140 in cooperation with the components in the medium conveying apparatus 100.

First, the control module 151 waits until an instruction to read a medium is input by a user by using the operation device 105 or the information processing apparatus and an operation signal providing an instruction to read a medium is received from the operation device 105 or the interface device 132 (step S101).

Next, the control module 151 acquires the medium signal from the medium sensor 111 and determines whether a medium is placed in the loading tray 103, based on the acquired medium signal (step S102). When a medium is not placed in the loading tray 103, the control module 151 ends the series of steps.

On the other hand, when a medium is placed in the loading tray 103, the control module 151 rotates the feed roller 112, the separation roller 113, the first conveyance roller 114, and/or the second conveyance roller 117 by driving the first motor 121 and the second motor 123 (step S103). Consequently, the control module 151 causes each roller to feed and convey a medium.

Next, the control module 151 causes the imaging device 116 to image a medium, acquires an input image from the imaging device 116, and outputs the acquired input image by transmitting the image to the information processing apparatus through the interface device 131 (step S104).

Next, the control module 151 determines whether a medium remains in the loading tray 103, based on the medium signal received from the medium sensor 113 (step S105). When a medium remains in the loading tray 103, the control module 151 returns the processing to step S104 and repeats the processing in step $104 and S105.

On the other hand, when a medium does not remain in the loading tray 103, the control module 151 controls the first motor 121 and the second motor 123 to stop the feed roller 112, the separation roller 113, the first conveyance roller 114, and/or the second conveyance roller 117 (step S106). Then, the control module 151 ends the series of steps.

As described in detail above, in the medium conveying apparatus 100, the diameter of a conveyance roller pair on the downstream side is less than the diameter of a conveyance roller pair on the upstream side while the pressing force generated by the conveyance roller pair on the downstream side is less than the pressing force generated by the conveyance roller pair on the upstream side. Alternatively, in the medium conveying apparatus 100, the hardness of the conveyance roller pair on the downstream side is lower than the hardness of the conveyance roller pair on the upstream side while the pressing force generated by the conveyance roller pair on the downstream side is less than the pressing force generated by the conveyance roller pair on the upstream side. Consequently, the medium conveying apparatus 100 can satisfactorily convey a medium while suppressing increase in the apparatus size and the apparatus cost by sharing the second motor 123 between a plurality of conveyance rollers.

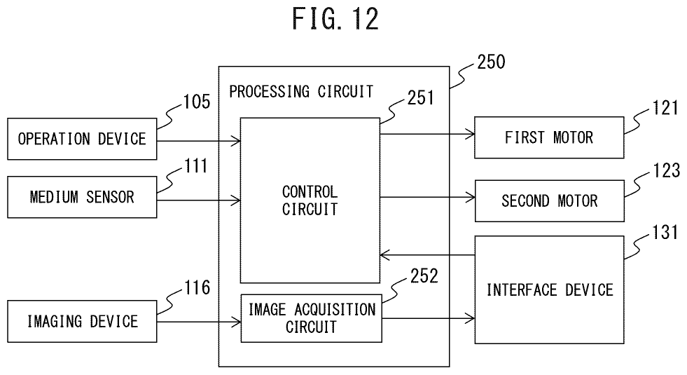

FIG. 12 is a diagram illustrating a schematic configuration of a processing circuit 250 in a medium conveying apparatus according to yet another embodiment. The processing circuit 250 is used in place of the processing circuit 150 in the medium conveying apparatus 100 and executes the medium reading processing, etc., in place of the processing circuit 150. The processing circuit 250 includes a control circuit 251, an image acquisition circuit 552, etc. Each component may be independently configured with an integrated circuit, a microprocessor, firmware, etc.

The control circuit 251 is an example of a control module and has a function similar to that of the control module 151. The control circuit 251 receives an operation signal from an operation device 105 or an interface device 131 and a medium signal from a medium sensor 111. The control circuit 251 controls a first motor 121 and a second motor 123, based on the received information.

The image acquisition circuit 252 is an example of an image acquisition module and has a function similar to that of the image acquisition module 152. The image acquisition circuit 252 acquires an input image from an imaging device 116 and outputs the acquired image to the interface device 131.

As described in detail above, the medium conveying apparatus can satisfactorily convey a medium when the processing circuit 250 is used as well.

While preferred embodiments have been described above, the embodiment is not limited thereto. For example, the medium conveying apparatus may be a printer to convey an object being printed on, etc., as a medium. In that case, the medium conveying apparatus includes a printing device in place of the imaging device 116. The printing device is located at the position where the imaging device 116 is located and executes printing processing on a medium conveyed by the first conveyance roller 114 and the first driven roller 115. The printing processing is an example of the predetermined processing. The medium conveying apparatus can suppress occurrence of bending of a conveyed medium (an object being printed on) and therefore can satisfactorily perform printing on the object being printed on.

### REFERENCE SIGNS LIST

100 MEDIUM CONVEYING APPARATUS, 112 Feed roller, 113 Separation roller, 114 First conveyance roller, 115 First driven roller, 115a First pressing member, 116 Imaging device, 117 Second conveyance roller, 118 Second driven roller, 118a Second pressing member

1. A medium conveying apparatus comprising:
a feed roller to feed a medium;
a separation roller located to face the feed roller and provided to be rotatable in a direction opposite to a medium feeding direction or stoppable;
a first conveyance roller pair located on a downstream side of the feed roller and the separation roller in a medium conveying direction to convey the medium fed by the feed roller while the separation roller is rotating in the direction opposite to the medium feeding direction or stopping;
a first pressing part to press one roller of the first conveyance roller pair to the other roller;
a processing device located on a downstream side of the first conveyance roller pair in the medium conveying direction to execute predetermined processing on the medium conveyed by the first conveyance roller pair;
a second conveyance roller pair located on a downstream side of the processing device in the medium conveying direction to convey the medium on which the predetermined processing is being executed by the processing device; and
a second pressing part to press one roller of the second conveyance roller pair to the other roller, wherein
a pressing force of the second pressing part is less than a pressing force of the first pressing part, wherein
at least one roller of the first conveyance roller pair and at least one roller of the second conveyance roller pair are driven by a same motor, and wherein
a diameter of at least one roller of the second conveyance roller pair is greater than a diameter of at least one roller of the first conveyance roller pair.

2. The medium conveying apparatus according to claim 1, wherein both rollers of the second conveyance roller pair have the same diameter, and both rollers of the first conveyance roller pair have the same diameter.

3. The medium conveying apparatus according to claim 1, wherein hardness of at least one roller of the second conveyance roller pair is lower than hardness of at least one roller of the first conveyance roller pair.

4. A medium conveying apparatus comprising:
a feed roller to feed a medium;
a separation roller located to face the feed roller and provided to be rotatable in a direction opposite to a medium feeding direction or stoppable;
a first conveyance roller pair located on a downstream side of the feed roller and the separation roller in a medium conveying direction to convey the medium fed by the feed roller while the separation roller is rotating in the direction opposite to the medium feeding direction or stopping;
a first pressing part to press one roller of the first conveyance roller pair to the other roller;
a processing device located on a downstream side of the first conveyance roller pair in the medium conveying direction to execute predetermined processing on the medium conveyed by the first conveyance roller pair;
a second conveyance roller pair located on a downstream side of the processing device in the medium conveying direction to convey the medium on which the predetermined processing is being executed by the processing device; and
a second pressing part to press one roller of the second conveyance roller pair to the other roller, wherein
a pressing force of the second pressing part is less than a pressing force of the first pressing part, wherein at least one roller of the first conveyance roller pair and at least one roller of the second conveyance roller pair are driven by a same motor, and wherein
hardness of at least one roller of the second conveyance roller pair is lower than hardness of at least one roller of the first conveyance roller pair.

5. The medium conveying apparatus according to claim 1, wherein a pressing force W1 of the first pressing part and a pressing force W2 of the second pressing part satisfy
$$W 1 / W 2 \geq 1.3 .$$

6. The medium conveying apparatus according to claim 1, further comprising a separation roller pressing part to press the separation roller to the feed roller, wherein
a pressing force W1 of the first pressing part and a pressing force W0 of the separation roller pressing part satisfy
$$W 1 / W 0 \geq 3 .$$
